(19) United States
(12) Patent Application Publication
(10) Pub. No.: US 2011/0249545 A1
(43) Pub. Date: Oct. 13, 2011

(54) Objective Lens and Optical Pickup Apparatus

(75) Inventors: Tohru Hotta, Okaya-shi (JP); Ryoichi Kawasaki, Isesaki-shi (JP)

(73) Assignees: Sanyo Optec Design Co., Ltd., Tokyo (JP); Sanyo Electric Co., Ltd., Osaka (JP)

(21) Appl. No.: 12/897,647

(22) Filed: Oct. 4, 2010

(30) Foreign Application Priority Data
Oct. 7, 2009 (JP) 2009-233732

(51) Int. Cl. G11B 7/135; G02B 5/18

(52) U.S. Cl. 369/108; 369/112.05; 359/574; 359/571; G9B/7.113

(57) ABSTRACT

An objective lens includes: a diffraction area having a diffraction structure provided thereon concentrically around an optical axis of the objective lens; and a first non-diffraction area provided outward an outer circumference of the diffraction area, the objective lens being configured to focus first laser light on a signal recording surface of a first optical recording medium by refraction in the first non-diffraction area; focus second laser light, different in wavelength from the first laser light, on a signal recording surface of a second optical recording medium by diffraction in the diffraction area; and focus third laser light, different in wavelength from the first laser light and the second laser light, on a signal recording surface of a third optical recording medium by diffraction in the diffraction area.

### CROSS-REFERENCE TO RELATED APPLICATION

This application claims the benefit of priority to Japanese Patent Application No. 2009-233732, filed Oct. 7, 2009, of which full contents are incorporated herein by reference.

### BACKGROUND OF THE INVENTION

1. Field of the Invention

The present invention relates to an objective lens and an optical pickup apparatus and also relates to an art for providing a small-sized and lightweight optical pickup apparatus.

2. Description of the Related Art

Recently, a large-capacity optical recording medium of a BD (Blu-ray Disc) standard has been becoming in widespread use which uses laser light of a blue-violet (blue) wavelength band of 400 nm to 420 nm (405 nm, for example). An optical pickup apparatus to be used for recording/reproducing of these optical recording media is also required to support an optical recording medium of a DVD (Digital Versatile Disc) standard, in which recording/reproducing is performed using laser light of a red wavelength band of 645 nm to 675 nm, and an optical recording medium of a CD (Compact Disc) standard, in which recording/reproducing is performed using laser light of an infrared wavelength band of 765 nm to 805 nm.

With regard to the optical pickup apparatus supporting these standards, Japanese laid-Open Patent Publication No. 2005-209299, for example, discloses that an objective lens, which appropriately condenses a light beam of a wavelength of 405 nm on a recording surface of a first optical recording medium, is combined with an optical element, which imparts phase difference distribution to the light beam of a wavelength of 650 nm and does not impart phase difference distribution to the light beam of a wavelength of 405 nm; and an objective lens, which is designed to appropriately condense the light beam of a wavelength of 405 nm on a recording surface of another optical disc is combined with an optical element, which imparts phase difference distribution to the light beam of a wavelength of 780 nm and does not impart the phase difference distribution to the light beam of a wavelength of 405 nm; and by means of these two combinations, information recording or reproducing is performed for four types of recording media, that is, a first to third optical recording media and another optical disc.

Portability and space saving have always been demanded for products such as AV equipment and computers which use optical pickup apparatuses, and the optical pickup apparatuses to be mounted thereon are required to be small sized and lightweight. However, with a configuration using a plurality of objective lenses as in the above patent publication, for example, component count is inevitably increased. Also, if a plurality of objective lenses are used, a configuration of a control system such as an actuator for driving them becomes complicated, and thus, it becomes difficult to satisfy the above demands.

### SUMMARY OF THE INVENTION

An objective lens according to an aspect of the present invention, includes: a diffraction area having a diffraction structure provided thereon concentrically around an optical axis of the objective lens; and a first non-diffraction area provided outward an outer circumference of the diffraction area, the objective lens being configured to focus first laser light on a signal recording surface of a first optical recording medium by refraction in the first non-diffraction area; focus second laser light, different in wavelength from the first laser light, on a signal recording surface of a second optical recording medium by diffraction in the diffraction area; and focus third laser light, different in wavelength from the first laser light and the second laser light, on a signal recording surface of a third optical recording medium by diffraction in the diffraction area.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating a configuration of an optical system of an optical pickup apparatus 1;

FIG. 2 is a block diagram illustrating an example of an optical-recording-medium recording/reproducing device 200;

FIG. 3 is a diagram illustrating a specification of an objective lens 20 according to a first embodiment of the present invention;

FIG. 4 is a diagram illustrating a principal point position in a first optical recording medium 5;

FIG. 5A is a diagram illustrating a moving radius and an aspheric coefficient of a lens surface on the collimating lens 18 side of the objective lens 20 according to a first embodiment of the present invention;

FIG. 5B is a diagram illustrating a moving radius and an aspheric coefficient of a lens surface on the optical recording medium 5 side of the objective lens 20 in a first embodiment of the present invention;

FIG. 6 is a diagram illustrating a phase function expression Φ(r);

FIG. 7 is a diagram illustrating a range in which a diffraction structure is provided and a sectional shape of the diffraction structure;

FIG. 8A is a diagram illustrating a state in which first laser light incident on the objective lens 20 from a quarter-wave plate 19 is focused on a signal recording surface of the first optical recording medium 5 by the objective lens 20;

FIG. 8B is a diagram illustrating a state in which second laser light incident on the objective lens 20 from the quarter-wave plate 19 is focused on a signal recording surface of the second optical recording medium 5 by the objective lens 20;

FIG. 8C is a diagram illustrating a state in which third laser light incident on the objective lens 20 from the quarter-wave plate 19 is focused on a signal recording surface of the third optical recording medium 5 by the objective lens 20;

FIG. 9 is a graph illustrating a relationship between a height of a blaze of the objective lens 20 (horizontal axis) and diffraction efficiency by a diffraction structure 70 (vertical axis) with respect to each of the first laser light (fourth-order diffracted light), the second laser light (second-order diffracted light), and the third laser light (second-order diffracted light), respectively;

FIG. 10 is a graph illustrating a result of comparison of DPP signals for detecting a tracking error;

FIG. 11 is a diagram illustrating a specification of the objective lens 20 according to a second embodiment of the present invention;

FIG. 12A is a diagram illustrating a moving radius and an aspheric coefficient on the collimating lens 18 side of the objective lens 20 according to a second embodiment of the present invention;

FIG. 12B is a diagram illustrating a moving radius and an aspheric coefficient of a lens surface on the optical recording medium 5 side of the objective lens 20 according to a second embodiment of the present invention;

FIG. 13 is a diagram illustrating a range in which a diffraction structure is provided and a sectional shape of the diffraction structure;

FIG. 14A is a diagram illustrating a state in which first laser light incident on the objective lens 20 from the quarter-wave plate 19 is focused on a signal recording surface of the first optical recording medium 5 by the objective lens 20;

FIG. 14B is a diagram illustrating a state in which second laser light incident on the objective lens 20 from the quarter-wave plate 19 is focused on a signal recording surface of the second optical recording medium 5 by the objective lens 20;

FIG. 14C is a diagram illustrating a state in which third laser light incident on the objective lens 20 from the quarter-wave plate 19 is focused on a signal recording surface of the third optical recording medium 5 by the objective lens 20;

FIG. 15 is a graph illustrating a relationship between a height of a blaze of the objective lens 20 (horizontal axis) and diffraction efficiency by a diffraction structure 70 (vertical axis) with respect to each of the first laser light (second-order diffracted light), the second laser light (first-order diffracted light), and the third laser light (first-order diffracted light), respectively; and

FIG. 16 is a graph illustrating a result of comparison of DPP signals for detecting a tracking error.

### DETAILED DESCRIPTION OF THE INVENTION

At least the following details will become apparent from descriptions of this specification and of the accompanying drawings.

### First Embodiment

An optical pickup apparatus 1, which will be described in an embodiment of the present invention, is such a device that applies a light flux to an optical recording medium 5 to be rotated and detects the light flux reflected from the optical recording medium 5. The optical pickup apparatus 1 is mounted on an information recording/reproducing device such as an optical-recording-medium recording/reproducing device 200, which will be described later, for example. The optical recording medium 5, for which information is recorded or reproduced by the optical pickup apparatus 1, includes the optical recording medium 5 of the BD (Blu-ray Disc) standard (hereinafter referred to as a first optical recording medium 5), the optical recording medium 5 of the DVD (Digital Versatile Disc) standard (hereinafter referred to as a second optical recording medium 5), and the optical recording medium 5 of the CD (Compact Disc) standard (hereinafter referred to as a third optical recording medium 5), for example.

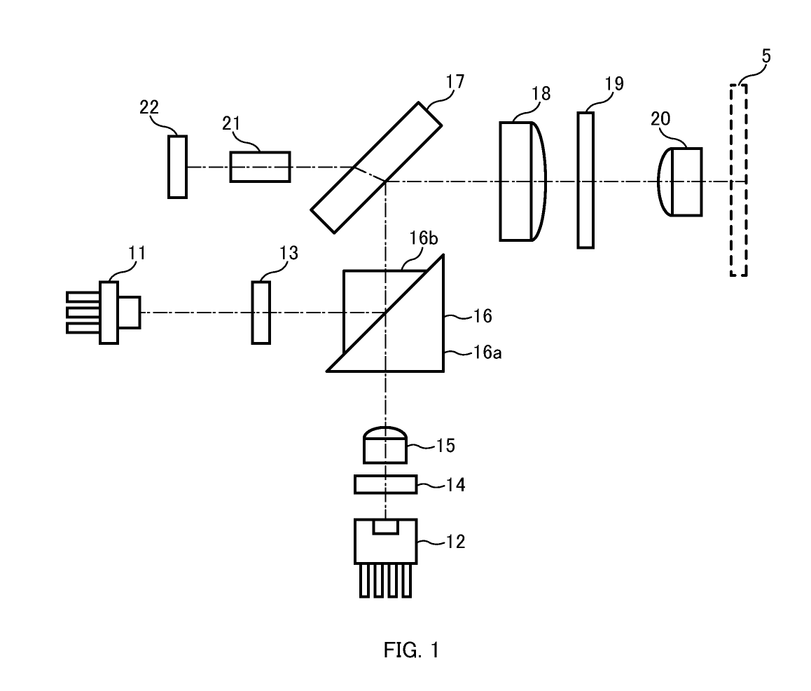

FIG. 1 illustrates a configuration of an optical system of the optical pickup apparatus 1 to be used for reproducing/recording a signal from/to the optical recording medium, which will be described in an embodiment of the present invention. As shown in the figure, the optical pickup apparatus 1 includes a first laser light source 11, a second laser light source 12, a first diffraction grating 13, a second diffraction grating 14, a coupling lens 15 (divergent lens), a polarizing beam splitter 16, a half mirror 17, a collimating lens 18, a quarter-wave plate 19, an objective lens 20, a detection lens 21, and a photodetector 22.

The first laser light source 11 emits first laser light having a first wavelength (blue-violet (blue) wavelength band of 400 nm to 420 nm (405 nm, for example)), with which signal reproducing/signal recording is performed for the first optical recording medium. The first laser light source 11 is configured using a light emitting element such as a semiconductor laser, for example.

The second laser light source 12 emits second laser light having a second wavelength (red wavelength band of 645 nm to 675 nm (655 nm, for example), with which signal reproducing/signal recording is performed for the second optical recording medium and third laser light having a third wavelength (infrared wavelength band of 765 nm to 805 nm (785 nm, for example), with which signal reproducing/signal recording is performed for the third optical recording medium.

The second laser light source 12 is configured using a semiconductor laser such as a two-wavelength laser diode. Also, the second laser light source 12 is configured preferably using a low-noise laser-light emitting element (Pulsation Laser element, for example), which oscillates by self-excited oscillation in a predetermined frequency range.

The first laser light emitted from the first laser light source 11 enters the first diffraction grating 13 arranged between the first laser light source 11 and the polarizing beam splitter 16. The first diffraction grating 13 includes, as constituents thereof, a diffraction grating that splits the first laser light into zero-order light, plus first-order light, and minus first-order light; and a half-wave plate that converts the incident first laser light into linearly polarized light which is S-polarized light relative to a polarization plane of the polarizing beam splitter 16.

The second laser light or the third laser light emitted from the second laser light source 12 enters the second diffraction grating 14 arranged between the second laser light source 12 and the polarizing beam splitter 16. The second diffraction grating 14 includes, as constituents thereof, a diffraction grating that splits the incident laser light into the zero-order light, the plus first-order light, and the minus first-order light; and a half-wave plate that converts the incident second laser light or third laser light into linearly polarized light which is P-polarized light relative to a polarization plane of the polarizing beam splitter 16.

The coupling lens 15, arranged between the second diffraction grating 14 and the polarizing beam splitter 16, converts an angle of divergence of the second laser light or the third laser light incident from the second laser light source 12. As the coupling lens 15, a divergent lens having a positive focal distance is used, for example.

In the optical systems illustrated in the figure, approximately 11 times is a total optical magnification of the optical system (hereinafter referred to as a first optical system) along an optical path of the first laser light including the collimating lens 18 and the objective lens 20, while approximately 5.5 to 6.0 times is a total optical magnification of the optical system (hereinafter referred to as a second optical system) along an optical path of the second laser light or the third laser light including the coupling lens 15, the collimating lens 18, and the objective lens 20.

Here, as shown in the figure, the optical pickup apparatus 1 according to an embodiment of the present invention has a configuration in which the collimating lens 18 and the objective lens 20 are shared between the first optical system and the second optical system, and thus, the synthetic magnification (total magnification) of the second optical system inevitably becomes high. However, by interposing the coupling lens 15 between the second diffraction grating 14 and the polarizing beam splitter 16, the synthetic magnification of the second optical system can be lowered. Thus, an inexpensive light source with a small emission output can be selected as the second laser light source 12.

The polarizing beam splitter 16 reflects the S-polarized first laser light that is incident from the first diffraction grating 13, and allows the P-polarized laser light (second laser light and the third laser light) that is incident from the coupling lens 15 to pass therethrough. The polarizing beam splitter 16 is in a substantially cube shape formed by joining two right angle prisms 16a and 16b of different sizes with their inclined surfaces opposed to each other. On the joined surfaces of the two prisms 16a and 16b, a file-structured polarization plane with a film structure (dielectric multi-layer film and the like) is formed which has such reflection/transmission characteristics of the first laser light, the second laser light, and the third laser light as described in an embodiment (See Japanese Patent Laid-Open Publication No. 2006-331594, for example).

The half mirror 17 reflects the incident S-polarized first laser light, which has been reflected by the polarizing beam splitter 16, and the incident P-polarized laser light (the second laser light or the third laser light), which has passed through the polarizing beam splitter 16, in a direction of the collimating lens 18. Also, the half mirror 17 allows return light of the first laser light and the return light of the second laser light or the third laser light, which is incident from the collimating lens 18, to pass therethrough.

The collimating lens 18 converts the first laser light, the second laser light or the third laser light, which is incident from the half mirror 17, into parallel light. The parallel light of the first laser light, the second laser light or the third laser light, which has been converted by the collimating lens 18, enters the quarter-wave plate 19.

The quarter-wave plate 19 converts the first laser light, the second laser light or the third laser light, which is incident from the collimating lens 18, from the linearly polarized light into circularly polarized light. Also, the quarter-wave plate 19 converts the return light of the first laser light, the return light of the second laser light or the return light of the third laser light, which is incident from the objective lens 20, from the circularly polarized light into the linearly polarized light.

The objective lens 20 is a lens compatible with three-wavelengths corresponding to the first to third wavelengths. The objective lens 20 condenses the first laser light, the second laser light or the third laser light, which is incident from the quarter-wave plate 19, to signal recording layer of the corresponding optical recording medium 5. The structure and functions will be described later of the three-wavelength compatible objective lens 20.

The return light of the first laser light, the return light of the second laser light or the return light of the third laser light, which has been reflected by the optical recording medium 5, is converted by the objective lens 20 into parallel light, enters the quarter-wave plate 19, and is converted by the quarter-wave plate 19 from the circularly polarized light into the linearly polarized light. The return light, which has been converted into the linearly polarized light, passes through the collimating lens 18, passes through the half mirror 17, and enters the detection lens 21.

The detection lens 21 condenses the return light to the photodetector 22, and generates a focus error signal by generating astigmatism in the return light. The detection lens 21 is formed by a cylindrical lens, a toric lens, an anamorphic lens or a parallel plate inclined relative to the optical axis, for example.

The photodetector 22 photoelectrically converts the received return light. The photodetector 22 is configured using a light receiving element such as a photodiode. The photodetector 22 includes light detection regions obtained by being divided into a plurality of parts (light detection regions obtained by dividing the light receiving regions, which supports the first to third laser light each divided by the first diffraction grating 13 or the second diffraction grating 14, into 12 parts (if a differential astigmatic method is employed as a focus control method) or into 8 parts (if the differential astigmatic method is not employed), for example). The light receiving regions respectively corresponding to the first to third laser light may be configured so as to be shared among the plurality of laser light (shared between the first laser light and the second laser light, for example).

The light receiving regions, respectively corresponding to the first to third laser light, each are set at such a position that a spot is not focused which is formed by the diffracted light (unnecessary diffracted light) of laser light other than the laser light to be received by each region (See Japanese Patent Laid-Open Publication No. 2007-164962, for example). A signal reproducing operation and a signal recording operation on the basis of a signal detected by the photodetector 22, a method of processing a signal detected by the photodetector 22, a tracking error detecting method by DPP (Differential Push Pull), etc., a focus error detecting method by the astigmatic method, etc., and the like, are all known, and the details thereof will be omitted.

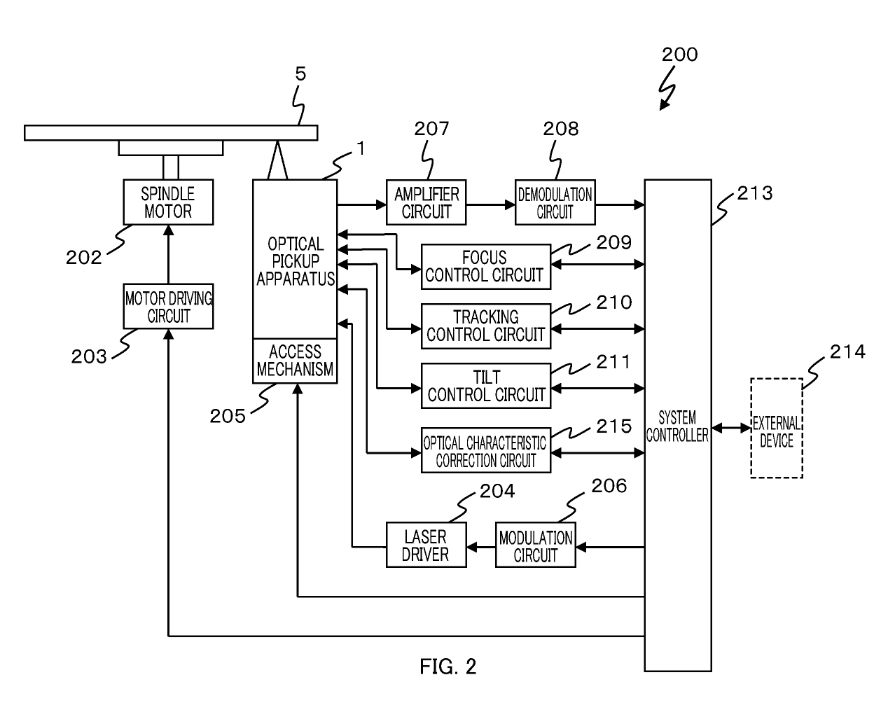

FIG. 2 is a block diagram illustrating an example of an optical-recording-medium recording/reproducing device 200 configured using the optical pickup apparatus 1 described above. As shown in the figure, the optical-recording-medium recording/reproducing device 200 includes the configuration of the above-described optical pickup apparatus 1 and further includes a spindle motor 202, a motor driving circuit 203, a laser driver 204, an access mechanism 205, a modulation circuit 206, an amplifier circuit 207, a demodulation circuit 208, a focus control circuit 209, a tracking control circuit 210, a tilt control circuit 211, an optical characteristic correction circuit 212, a system controller 213, and an external device 214.

In this figure, the spindle motor 202 rotates the optical recording medium 5. The motor driving circuit 203 controls rotation of the spindle motor 202 according to a control signal sent from the system controller 213.

The access mechanism 205 moves the optical pickup apparatus 1 according to a control signal sent from the system controller 213 in a radial direction of the optical recording medium 5.

The laser driver 204 controls an output of the laser light emitted from the first laser light source 11 and the second laser light source 12 according to a signal inputted from the modulation circuit 206.

The modulation circuit 206 modulates data, which is inputted from the system controller 213 and is to be recorded in the optical recording medium 5, to a pulse signal for recording. The data to be recorded in the optical recording medium 5 is supplied as needed from the external device 214 such as a personal computer through the system controller 213, for example.

The amplifier circuit 207 amplifies an RF signal (RF: Radio Frequency) contained in an electric signal outputted from the photodetector 22 of the optical pickup apparatus 1, and outputs the amplified signal to the demodulation circuit 208. The demodulation circuit 208 demodulates the RF signal inputted from the amplifier circuit 207, and outputs the demodulated signal to the system controller 213. The system controller 213 outputs a data signal, which is based on the demodulation signal inputted from the demodulation circuit 208, to the external device 214.

The focus control circuit 209, the tracking control circuit 210, and the tilt control circuit 211 perform driving control of the objective lens 20. Among them, the focus control circuit 209 detects a focus error signal contained in the electric signal outputted from the photodetector 22 of the optical pickup apparatus 1, and performs focus control of the objective lens 20 based on the detected focus error signal. The tracking control circuit 210 detects a tracking error signal contained in the electric signal outputted from the photodetector 22 of the optical pickup apparatus 1, and performs tracking control of the objective lens 20 based on the detected tracking error signal. The tilt control circuit 211 detects a tilt error signal contained in the electric signal outputted from the photodetector 22 of the optical pickup apparatus 1, and performs tilt control of the objective lens 20 based on the detected tilt error signal.

An optical characteristic correction circuit 215 corrects deterioration of optical characteristics of the objective lens resulting from a temperature change. The optical characteristic correction circuit 215 also corrects spherical aberration caused by a difference in cover thickness of each optical recording medium 5 or a difference in cover thickness of each layer in the optical recording medium with a multi-layer structure. The correction method includes such a magnification characteristic method as to utilize a degree of divergence/convergence with respect to a design value of a light flux incident on the objective lens 20, and such a spherical aberration method that spherical aberration is corrected by generating the spherical aberration of reversed polarity using a liquid crystal element, for example. The optical characteristic correction circuit 215 corrects the optical characteristics by moving the collimating lens 18 in the optical axis direction, for example (See Japanese patent Laid-Open Publication No. 2008-234803, for example).

### <Objective Lens>

The objective lens 20 in the optical pickup apparatus 1 according to an embodiment of the present invention is made of a material such as a resin and glass. As mentioned above, the objective lens 20 is a lens compatible with three wavelengths corresponding to the first to third wavelengths, and condenses (forms a spot of) the first laser light of the first wavelength (blue light of 405 nm) on the signal recording surface of the first optical recording medium 5, condenses the second laser light of the second wavelength (red light of 655 nm) on the signal recording surface of the second optical recording medium 5, and condenses the third laser light of the third wavelength (infrared light of 785 nm) on the signal recording surface of the third optical recording medium 5.

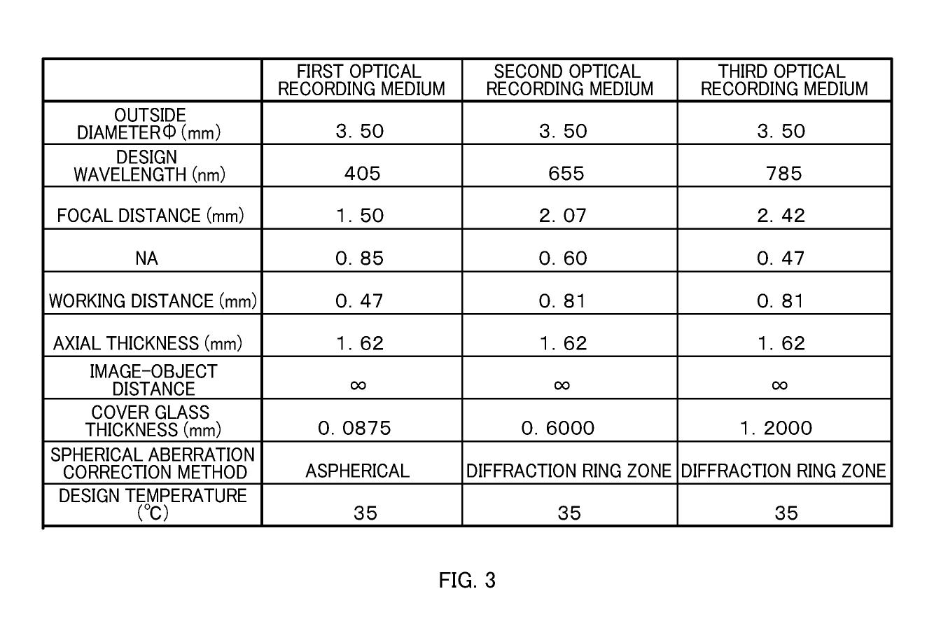

FIG. 3 shows a specification of the objective lens 20. As shown in the figure, an outside diameter, that is, an effective diameter (diameter) of the objective lens 20 is 3.50 mm. As shown in the figure, the objective lens 20 functions as a lens with a numerical aperture (hereinafter referred to as NA) of 0.85 in recording/reproducing of the first optical recording medium 5, functions as a lens with NA of 0.60 in recording/reproducing of the second optical recording medium 5, and functions as a lens with NA of 0.47 in recording/reproducing of the third optical recording medium 5.

As shown in FIG. 3, a working distance WD is 0.47 mm in the recording/reproducing of the first optical recording medium 5 that is performed using the first laser light, the working distance WD is 0.81 mm in the recording/reproducing of the second optical recording medium 5 that is performed using the second laser light, and the working distance WD is 0.81 mm in the recording/reproducing of the third optical recording medium 5 that is performed using the third laser light.

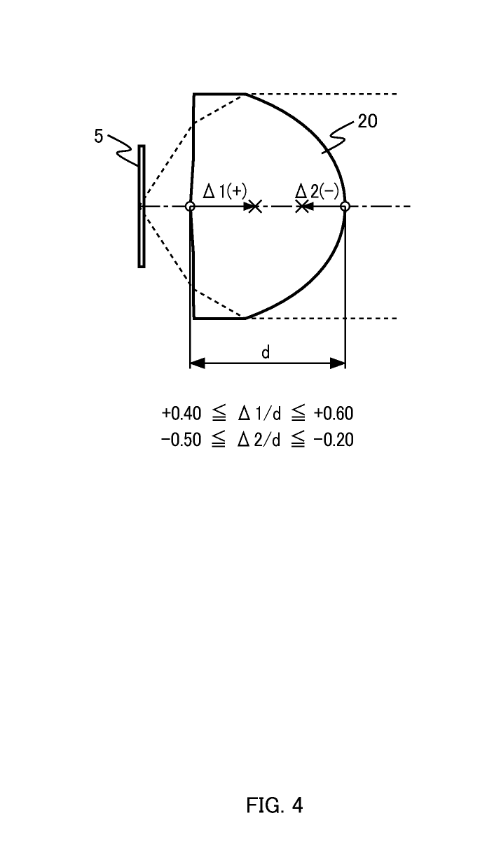

FIG. 4 illustrates a principal point position of the objective lens 20 based on a light collection point (focused point) in the first optical recording medium 5. As shown in the figure, the position of a front-side principal point Δ1(+) of the objective lens 20 is in the range of +0.40≦Δ1/d≦+0.60, where d denotes a distance between surface tops (distance between an incident surface top and an emitting surface top). Also, the position of a rear side principal point Δ2(−) is in the range of −0.50≦Δ2/d≦−0.20.

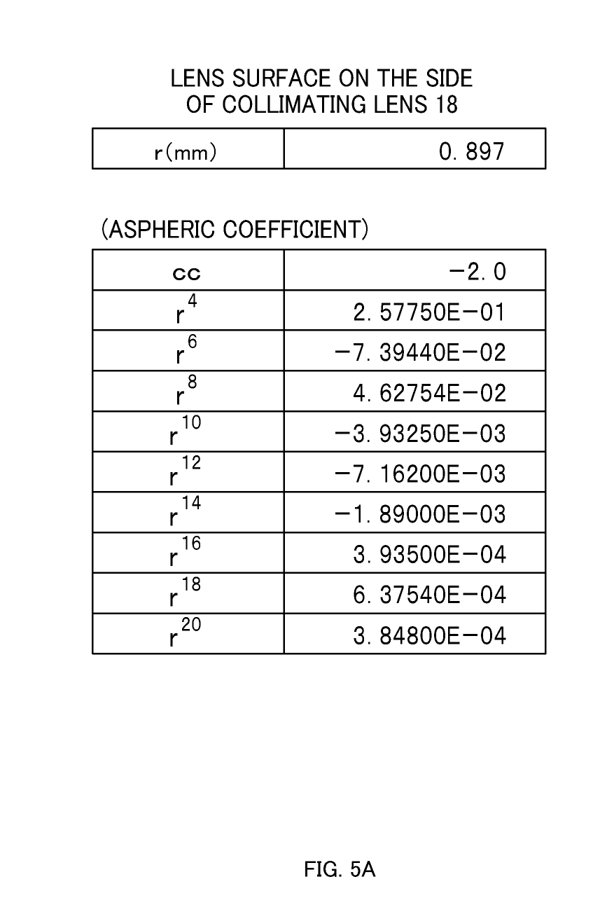

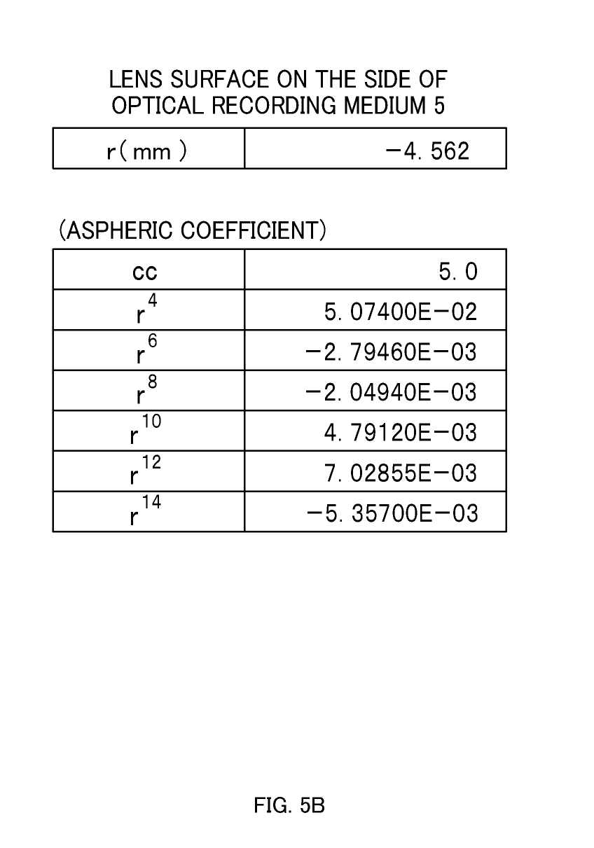

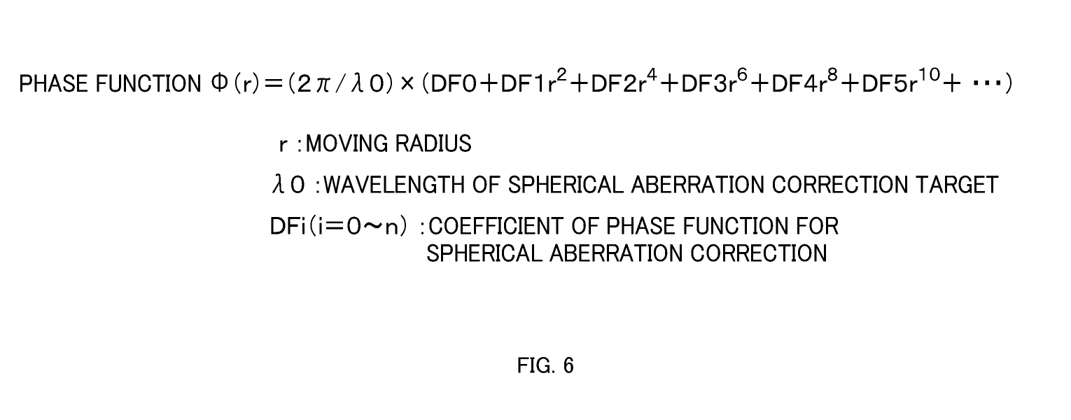

FIG. 5A illustrates a moving radius and an aspheric coefficient of a lens surface on the collimating lens 18 side of the objective lens 20 when the shape of the objective lens 20 is expressed by a phase function expression Φ(r) shown in FIG. 6. FIG. 5B is a moving radius and an aspheric coefficient of a lens surface on the optical recording medium 5 side of the objective lens 20 when the shape of the objective lens 20 is expressed by the phase function expression Φ(r) shown in FIG. 6. In FIGS. 5A and 5B, r is a moving radius and cc is a conic coefficient.

A diffraction structure 70 is provided in a predetermined range on the surface of the collimating lens 18 side of the objective lens 20. The first to third laser light incident on the objective lens 20 from the collimating lens 18 are condensed onto the signal recording surfaces of the first to third optical recording media 5 by a refraction effect of the objective lens 20 or a diffraction effect of the diffraction structure 70.

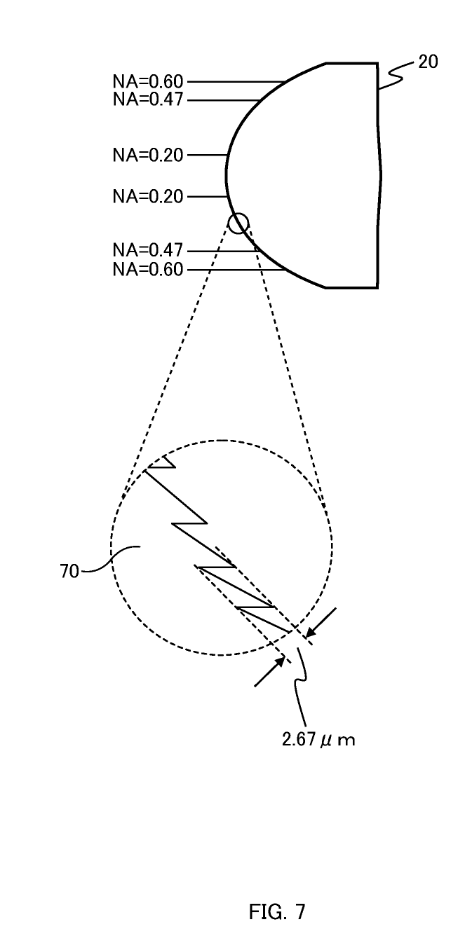

FIG. 7 shows a range, in which the diffraction structure 70 is provided, on the lens surface of the objective lens 20, and a sectional shape of the diffraction structure 70. As shown in the figure, in the objective lens 20 according to a first embodiment of the present invention, a blaze diffraction grating is mounted, as the diffraction structure 70, on the objective lens 20 in the range (diffraction area) of 0.20<NA≦0.60. On the lens surface on the collimating lens 18 side of the objective lens 20, a plurality of blazes are formed concentrically around the optical axis of the objective lens 20. The height of each blaze is 2.67 μm. The blazes formed therearound are different in shape between those formed in the range of 0.20<NA≦0.47 (first diffraction area) and those formed in the range of 0.47<NA≦0.60 (second diffraction area).

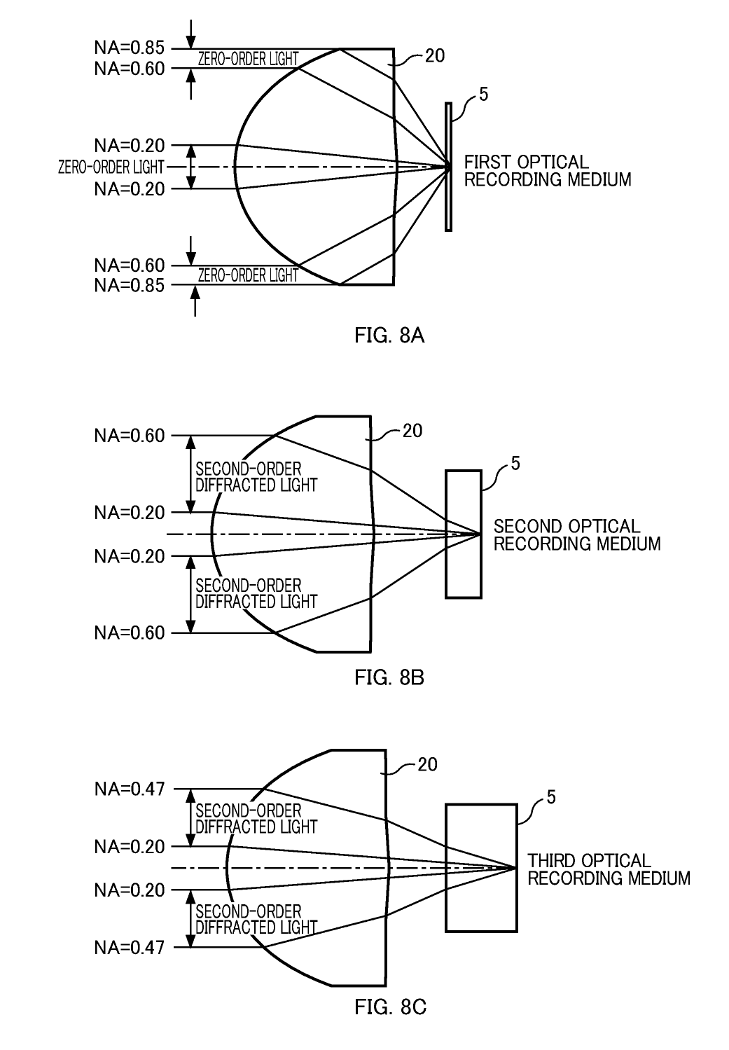

FIGS. 8A to 8C all are diagrams of the objective lens 20 seen from the side thereof. In these figures, states are shown in which the first to third laser light is condensed on the signal recording surfaces of the first to third optical recording media 5 by the refraction effect of the objective lens 20 or the diffraction effect of the diffraction structure 70.

FIG. 8A shows a state in which the first laser light is focused on the signal recording surface of the first optical recording medium 5 by the objective lens 20. As shown in the figure, the first laser light (zero-order light), which is incident on the objective lens 20 in the range of NA≦0.20 (second non-diffraction area) or 0.60<NA (first non-diffraction area), is focused on the signal recording surface of the first optical recording medium 5 by the refraction effect of the objective lens 20. The first non-diffraction area is provided outward an outer circumference of the first diffraction area, and the second non-diffraction area is provided inward an inner circumference of the diffraction area and includes the inner circumference. On the other hand, the first laser light, which is incident thereon in the range of 0.20<NA≦0.60 (diffraction area=first diffraction area+second diffraction area), becomes a fourth-order diffracted light by the diffraction structure 70 and does not basically contribute to formation of a spot.

FIG. 8B shows a state in which the second laser light is focused on the signal recording surface of the second optical recording medium 5 by the objective lens 20. As shown in the figure, the second laser light, which is incident thereon in the range of 0.20<NA≦0.60 (diffraction area=first diffraction area+second diffraction area), is diffracted by the diffraction structure 70, and the second-order diffracted light generated thereby is focused on the signal recording surface of the second optical recording medium 5. The refracted light in the area where the blaze of the diffraction structure 70 is not formed (NA≦0.20 (second non-diffraction area) or 0.60<NA (first non-diffraction area)) does not basically contribute to formation of a spot. This is because the lens surface of the objective lens 20 is in a curved shape with a large curvature supporting the first laser light (BD standard).

FIG. 8C shows a state in which the third laser light is focused on the signal recording surface of the third optical recording medium 5 by the objective lens 20. As shown in the figure, second-order diffracted light obtained by diffracting the third laser light, which is incident thereon in the range of 0.20<NA≦0.47 (first diffraction area), by the diffraction structure 70 is focused on the signal recording surface of the third optical recording medium 5. The refracted light in the range where the blaze of the diffraction structure 70 is not formed (NA≦0.20 (second non-diffraction area) or 0.60<NA (first non-diffraction area)) does not basically contribute to formation of a spot. That is because the lens surface of the objective lens 20 is in a curved shape with a large curvature supporting the first laser light (BD standard).

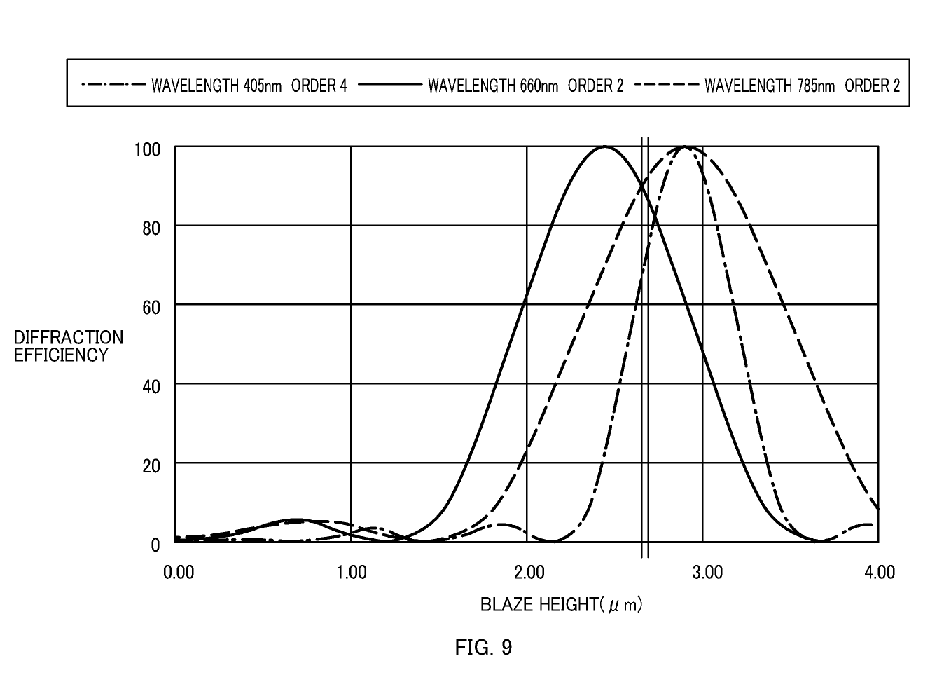

FIG. 9 is a graph illustrating a relationship between the height (horizontal axis) of the blaze of the objective lens 20 and the diffraction efficiency (vertical axis) by the diffraction structure 70 with respect to each of the first laser light (fourth-order diffracted light), the second laser light (second-order diffracted light), and the third laser light (second-order diffracted light). As illustrated in the figure, it is understood that if the height of the blaze is 2.67 μm, a high diffraction efficiency (90% or more in both cases) can be obtained for both the second laser light (second-order diffracted light) and the third laser light (second-order diffracted light).

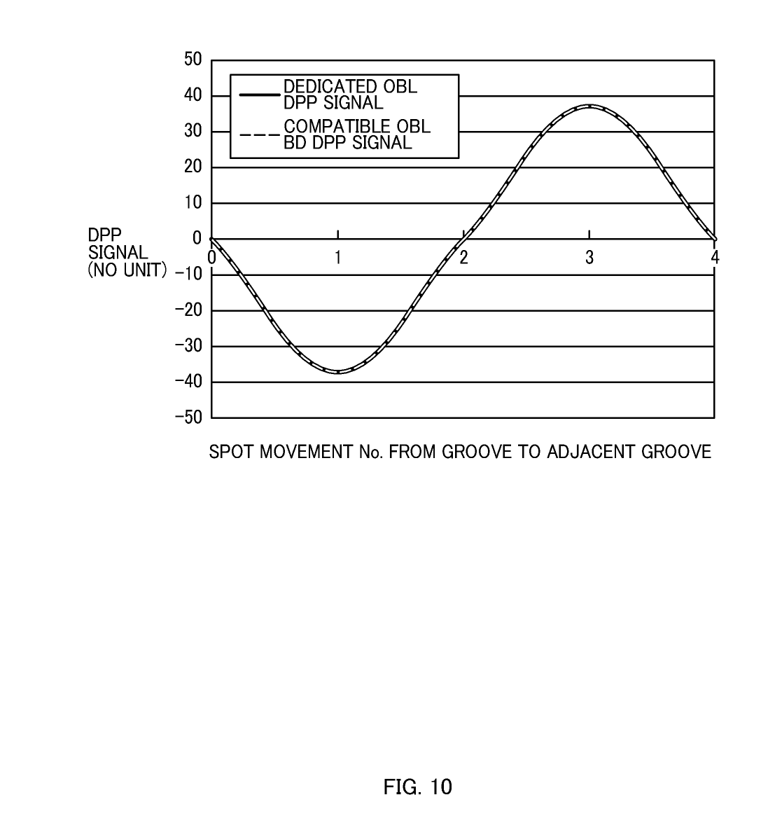

FIG. 10 is a graph illustrating a result of comparison of DPP signals for detecting a tracking error as to each of the three-wavelength compatible objective lens 20 described above and the (BD standard) objective lens 20 dedicated to the first laser light provided as a target for comparison. The horizontal axis of the graph indicates a movement number of a spot from a groove provided on the surface of the first optical recording medium 5 to an adjacent groove, while the vertical axis indicates the magnitude of the DPP signal. As shown in the figure, even if the three-wavelength compatible objective lens 20 according to an embodiment of the present invention is used, the DPP signal is substantially identical to the DPP signal when the objective lens 20 dedicated to the first laser light is used, and it is understood that the tracking error detection can be effectively performed even by the three-wavelength compatible objective lens 20.

In the optical pickup apparatus 1 according to an embodiment of the present invention as described above, as to the first laser light, the refracted light (zero-order light) thereof is focused on the signal recording surface of the first optical recording medium 5. Thus, high light-use efficiency can be obtained in the first laser light. In the first laser light, by using the refracted light thereof as such, it can effectively be prevented that sidelobes are increased in intensity due to a super-resolution effect and noise is generated due to interference with an adjacent signal pit.

With regard to the second laser light and the third laser light, each second-order diffracted light thereof is focused on the signal recording surface of the second optical recording medium 5 or the third optical recording medium 5. Thus, high light-use efficiency can be obtained both in the second laser light and the third laser light. Also, even though in the three-wavelength compatible objective lens 20, the working distance WD in the objective lens 20 to the surface of a transparent substrate covering the signal recording surface of the optical recording medium 5 can be sufficiently ensured in any of the first to third optical recording media 5.

### Second Embodiment

The optical pickup apparatus 1 according to a second embodiment of the present invention has a basic configuration common with that of the optical pickup apparatus 1 according to first embodiment of the present invention, but is different from a first embodiment in the configuration of the objective lens 20.

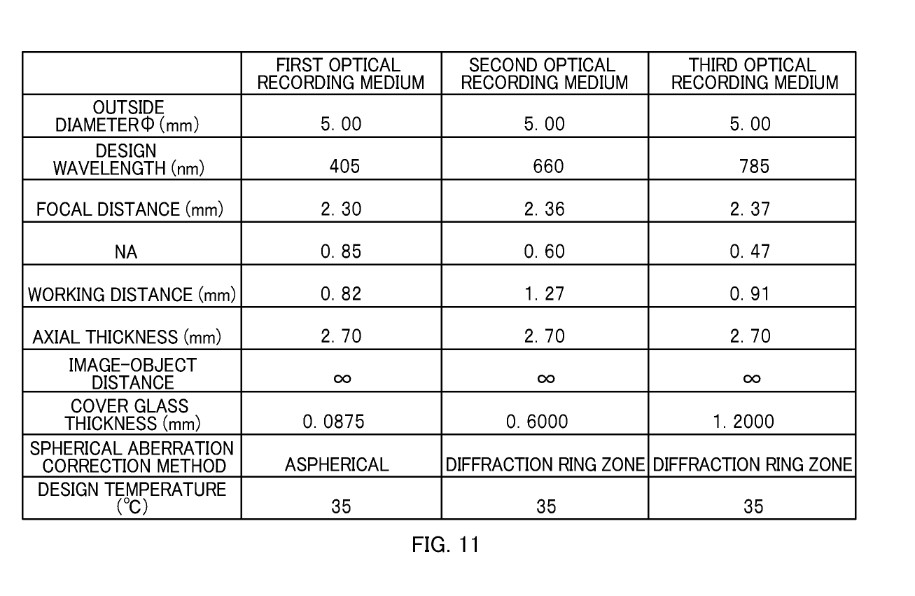

FIG. 11 shows a specification of the objective lens 20 according to a second embodiment of the present invention. As shown in the figure, the objective lens 20 according to a second embodiment of the present invention has an effective diameter of 5.00 mm, which is greater than the effective diameter of the objective lens 20 according to a first embodiment of the present invention.

Also, as shown in the figure, the working distance WD is 0.82 mm in the recording/reproducing of the first optical recording medium 5 that is performed using the first laser light, the working distance WD is 1.27 mm in the recording/reproducing of the second optical recording medium 5 performed using the second laser light, and the working distance WD is 0.91 mm in the recording/reproducing of the third optical recording medium that is performed using the third laser light.

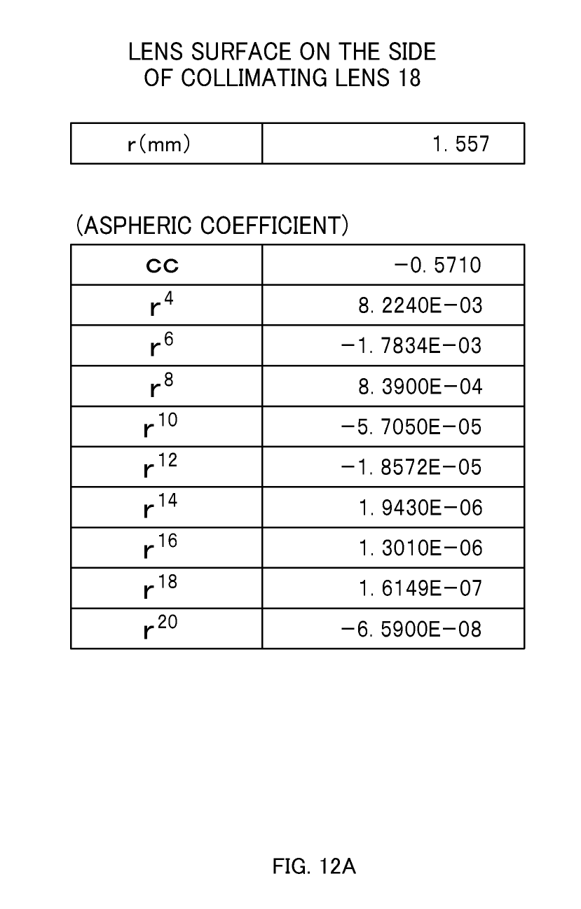

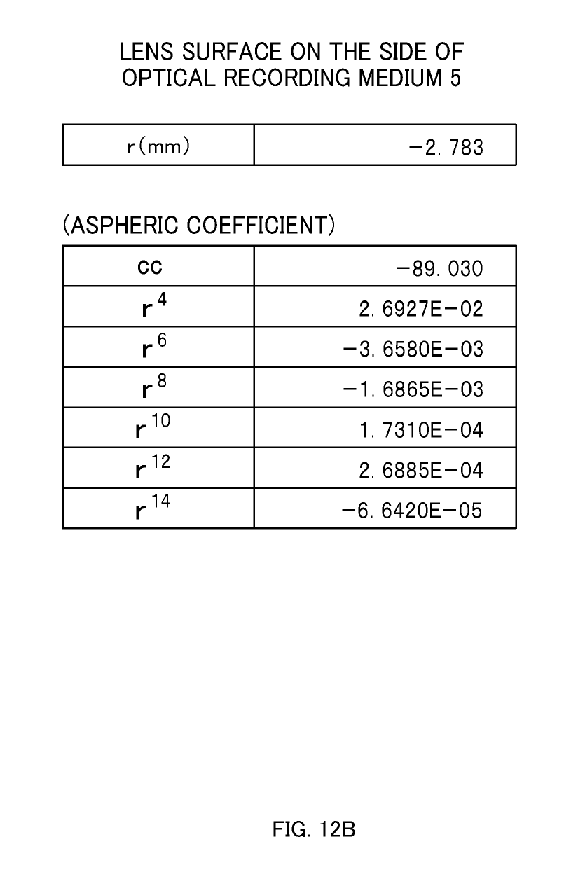

FIG. 12A is a moving radius and an aspheric coefficient of a lens surface on the collimating lens 18 side of the objective lens 20 when the specification of the objective lens 20 according to a second embodiment of the present invention is expressed by the phase function expression Φ(r) shown in FIG. 6. FIG. 12B is a moving radius and an aspheric coefficient of a lens surface on the optical recording medium 5 side of the objective lens 20 according to a second embodiment of the present invention when the shape of the objective lens 20 is expressed by the phase function expression Φ(r) shown in FIG. 6. In FIGS. 12A and 12B, r is a moving radius and cc is a conic coefficient.

Similarly to a first embodiment of the present invention, a diffraction structure 70 is provided in a predetermined range on the surface of the collimating lens 18 side of the objective lens 20. The first to third laser light incident on the objective lens 20 from the collimating lens 18 are condensed on the signal recording surfaces of the first to third optical recording media 5 by a refraction effect of the objective lens 20 or a diffraction effect of the diffraction structure 70.

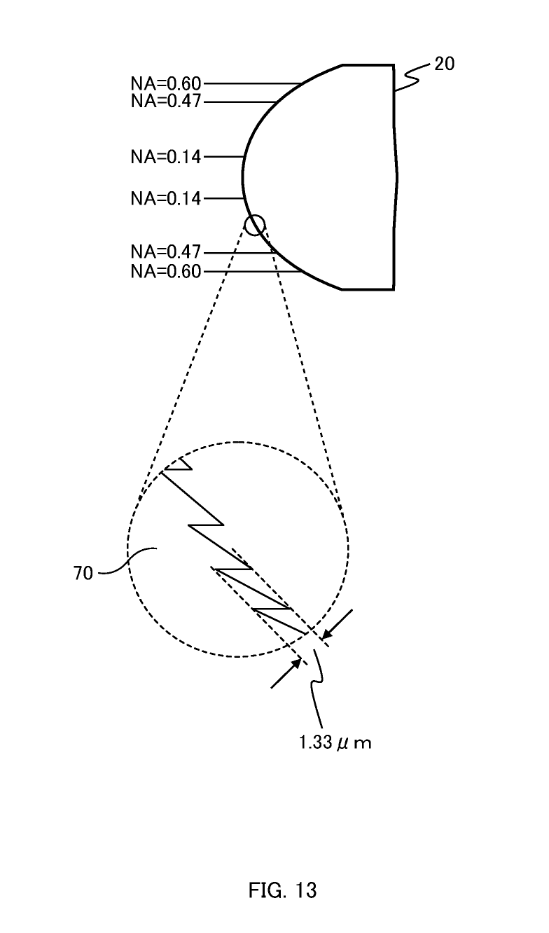

FIG. 13 shows a range, in which the diffraction structure 70 of the objective lens 20 is provided, on the lens surface of the objective lens 20, and a sectional shape of the diffraction structure 70. As shown in the figure, in the objective lens 20, a blaze diffraction grating is formed, as the diffraction structure 70, on the objective lens 20 in the range (diffraction area) of 0.14<NA≦0.60. As shown in the figure, a plurality of blazes are formed concentrically around the optical axis of the objective lens 20. The height of each blaze is 1.33 μm. The blazes formed therearound are different in shape between those formed in the range of 0.14<NA≦0.47 (first diffraction area) and those formed in the range of 0.47<NA≦0.60 (second diffraction area).

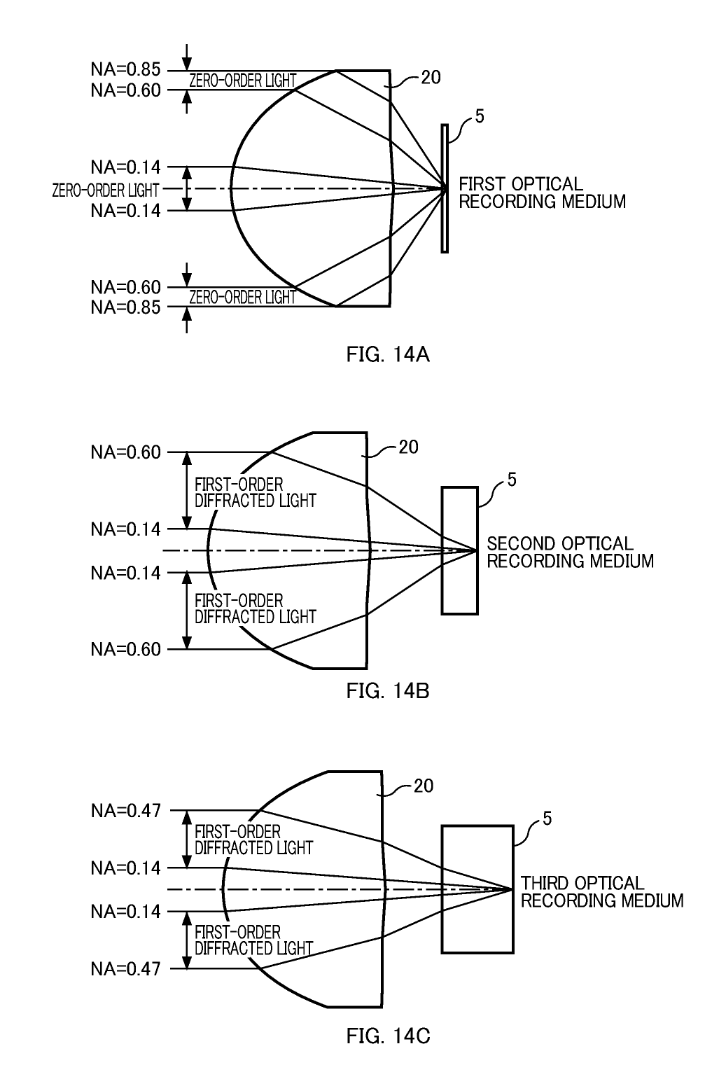

FIGS. 14A to 14C all are diagrams of the objective lens 20 seen from the side thereof. In these figures, states are shown in which the first to third laser light is condensed on the signal recording surfaces of the first to third optical recording media 5 by the refraction effect of the objective lens 20 or the diffraction effect of the diffraction structure 70.

FIG. 14A shows a state in which the first laser light is focused on the signal recording surface of the first optical recording medium 5 by the objective lens 20. As shown in the figure, the first laser light (zero-order light), which is incident on the objective lens 20 in the range of NA≦0.14 (second non-diffraction area) or 0.60<NA (first non-diffraction area) is focused on the signal recording surface of the first optical recording medium 5 by the refraction effect of the objective lens 20. On the other hand, the first laser light, which is incident thereon in the range of 0.14<NA≦0.60 (diffraction area=first diffraction area+second diffraction area) is diffracted by the diffraction structure 70 and does not basically contribute to formation of a spot.

FIG. 14B shows a state in which the second laser light is focused on the signal recording surface of the second optical recording medium 5 by the objective lens 20. As shown in the figure, the second laser light, which is incident on the objective lens 20 in the range of 0.14<NA≦0.60 (diffraction area=first diffraction area+second diffraction area), is diffracted by the diffraction structure 70, and the first-order diffracted light generated thereby is focused on the signal recording surface of the second optical recording medium 5. The refracted light in the range where the blaze of the diffraction structure 70 is not formed (NA≦0.14 (second non-diffraction area) or 0.60<NA (first non-diffraction area)) does not basically contribute to formation of a spot. This is because the lens surface of the objective lens 20 is in a curved shape with a large curvature supporting the first laser light (BD standard).

FIG. 14C shows a state in which the third laser light is focused on the signal recording surface of the third optical recording medium 5 by the objective lens 20. As shown in the figure, the third laser light incident thereon in the range of 0.14<NA≦0.47 (first diffraction area) is diffracted by the diffraction structure 70, and the first-order diffracted light generated thereby is focused on the signal recording surface of the third optical recording medium 5. The refracted light in the range where the blaze of the diffraction structure 70 is not formed (NA≦0.14 (second non-diffraction area) or 0.60<NA (first non-diffraction area)) does not basically contribute to formation of a spot. This is because the lens surface of the objective lens 20 is in a curved shape with a large curvature supporting the first laser light (BD standard).

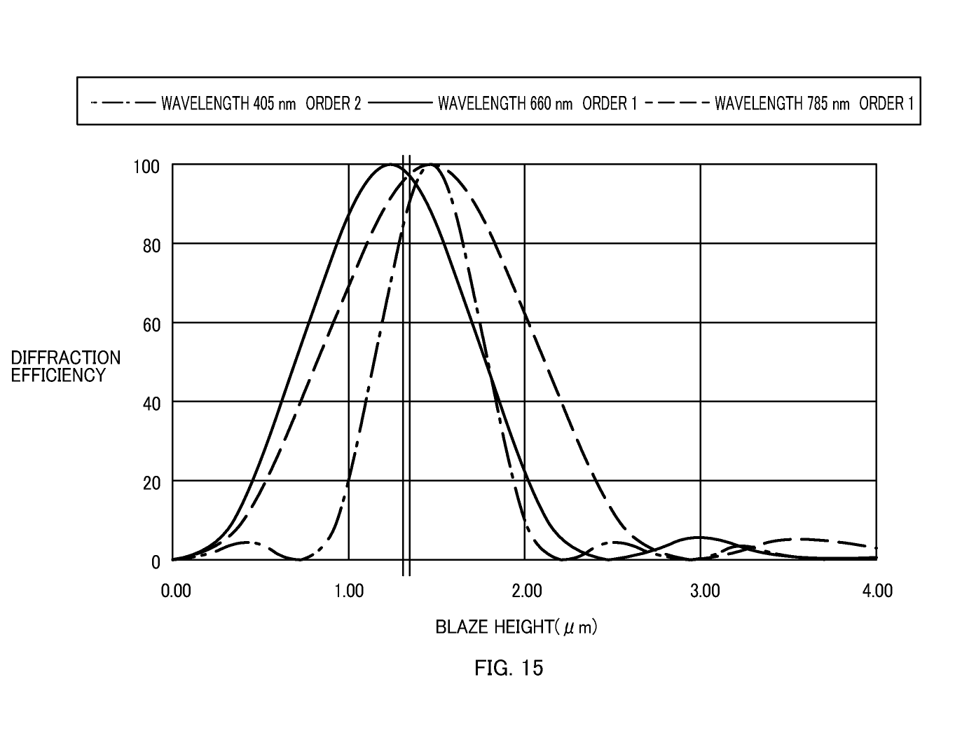

FIG. 15 is a graph illustrating a relationship between the height (horizontal axis) of the blaze of the objective lens 20 and the diffraction efficiency (vertical axis) by the diffraction structure 70 of each of the first laser light (second-order diffracted light), the second laser light (first-order diffracted light), and the third laser light (first-order diffracted light). As illustrated in the figure, it is understood that if the height of the blaze is 1.33 μm, the diffraction efficiency of the first laser light (second-order diffracted light) in the range (range of 0.14<NA≦0.60 (diffraction area) where the diffraction structure 70 is formed becomes 60% or less, and little contribution is made to the collection light condensed to the optical recording medium 5. Also, it is understood that a high diffraction efficiency (90% or more in both cases) can be obtained for both the second laser light (first-order diffracted light) and the third laser light (first-order diffracted light).

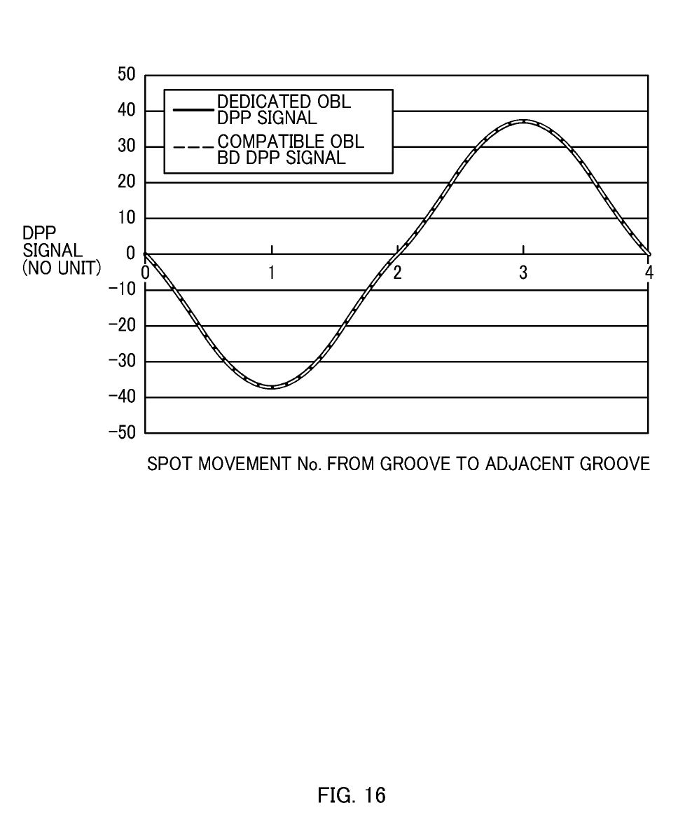

FIG. 16 is a graph illustrating a result of comparison of DPP signals for detecting a tracking error as to each of the three-wavelength compatible objective lens 20 described above and the (BD standard) objective lens 20 dedicated to the first laser light provided as a target for comparison. The horizontal axis of the graph indicates a movement number of a spot from a groove provided on the surface of the first optical recording medium 5 to an adjacent groove, while the vertical axis indicates the magnitude of the DPP signal. As shown in the figure, even if the three-wavelength compatible objective lens 20 according to an embodiment of the present invention is used, the DPP signal is substantially identical to the DPP signal when the objective lens 20 dedicated to the first laser light is used, and it is understood that the tracking error detection can be effectively performed even by the three-wavelength compatible objective lens 20.

In the optical pickup apparatus 1 according to an embodiment of the present invention as described above, as to the first laser light, the refracted light (zero-order light) thereof is focused on the signal recording surface of the first optical recording medium 5. Thus, high light-use efficiency can be obtained in the first laser light. In the first laser light, by using the zero-order light thereof as such, it can effectively be prevented that sidelobes are increased in intensity due to a super-resolution effect and noise is generated due to interference with an adjacent signal pit.

Also, with regard to the second laser light and the third laser light, each first-order diffracted light thereof is focused on the signal recording surface of the second optical recording medium 5 or the third optical recording medium 5. Thus, high light-use efficiency can be obtained both in the second laser light and the third laser light.

Also, with regard to the second laser light and the third laser light, each laser light condensed by the second non-diffraction area is not focused on the signal recording surface of the second optical recording medium 5 or the third optical recording medium 5, which has advantage to ensure the working distance WD of the objective lens 20 in the second optical recording medium 5 or the third optical recording medium 5. Particularly, in the case of the CD (third recording medium 5), since the transparent substrate covering the signal recording surface is greater in thickness than that of the first or second optical recording medium 5 (DVD or BD), it is difficult to ensure the working distance WD of the objective lens 20. However, since the laser light condensed by the second non-diffraction area is not focused on the signal recording surface as such, the working distance WD of the objective lens 20 can be sufficiently ensured. Therefore, even in the three-wavelength compatible objective lens 20, the sufficient working distance WD can be ensured for any of the first to third optical recording media 5.

The above embodiments of the present invention are simply for facilitating the understanding of the present invention and are not in any way to be construed as limiting the present invention. The present invention may variously be changed or altered without departing from its spirit and encompass equivalents thereof.

In embodiments as described above, the diffraction structure is provided on the surface of the objective lens 20, however, the diffraction structure may be separately mounted on other object instead of the objective lens 20, for example. Also, the diffraction structure is not limited to the diffraction grating, but it may be a hologram or the like.

What is claimed is:

1. An objective lens comprising:
a diffraction area having a diffraction structure provided thereon concentrically around an optical axis of the objective lens; and
a first non-diffraction area provided outward an outer circumference of the diffraction area,
the objective lens being configured to
focus first laser light on a signal recording surface of a first optical recording medium by refraction in the first non-diffraction area;
focus second laser light, different in wavelength from the first laser light, on a signal recording surface of a second optical recording medium by diffraction in the diffraction area; and
focus third laser light, different in wavelength from the first laser light and the second laser light, on a signal recording surface of a third optical recording medium by diffraction in the diffraction area.

2. The objective lens according to claim 1, wherein
the diffraction area includes a first diffraction area allowing the third laser light to be focused on the signal recording surface of the third optical recording medium and a second diffraction area provided outward the outer circumference of the first diffraction area, and wherein
the second diffraction area doses not allow the third laser light to be focused on the signal recording surface of the third optical recording medium.

3. The objective lens according to claim 1, wherein
a second non-diffraction area is provided inward an inner circumference of the diffraction area and includes the inner circumference.

4. The objective lens according to claim 3, wherein
the third laser light allowed to pass through the second non-diffraction area and be condensed is not focused on the signal recording surface of the third optical recording medium.

5. The objective lens according to claim 1, configured to
focus zero-order light of the first laser light on the signal recording surface of the first optical recording medium,
focus second-order diffracted light of the second laser light on the signal recording surface of the second optical recording medium, and
focus second-order diffracted light of the third laser light on the signal recording surface of the third optical recording medium.

6. The objective lens according to claim 5, wherein
the first laser light has a blue-violet wavelength band of 400 nm to 420 nm; wherein
the second laser light has a red wavelength band of 645 nm to 675 nm; wherein
the third laser light has an infrared wavelength band of 765 nm to 805 nm; wherein
NA (Numerical Aperture) is 0.85; wherein
the zero-order light of the first laser light allowed to pass through the objective lens in a range of 0.60<NA, which is the first non-diffraction area, or NA≦0.20, which is the second non-diffraction area, is focused on the signal recording surface of the first optical recording medium; wherein
the second-order diffracted light of the second laser light allowed to pass through the objective lens in a range of 0.20<NA≦0.60, which is the diffraction area, is focused on the signal recording surface of the second optical recording medium; and wherein
the second-order diffracted light of the third laser light allowed to pass through the objective lens in a range of 0.20<NA≦0.47 of the objective lens, which is the diffraction area, is focused on the signal recording surface of the third optical recording medium.

7. The objective lens according to claim 5, wherein
the objective lens has a blaze diffraction grating formed, as the diffraction structure, on a lens surface thereof on a side on which the first to third laser light is incident.

8. The objective lens according to claim 7, wherein
the blaze diffraction grating having a blaze height of 2.67 μm is formed on the objective lens in a range of 0.20<NA≦0.60.

9. The objective lens according to claim 5, wherein
a front-side principal point position Δ1 and a rear-side principal point position Δ2 based on a light collection point of the zero-order light of the first optical recording medium satisfy the following relationships:
+0.40≦Δ1/d≦+0.60
−0.50≦Δ2/d≦−0.20
where d denotes a distance between surface tops of the objective lens.

10. The objective lens according to claim 5, wherein
an outside diameter is 3.5 mm.

11. The objective lens according to claim 1, wherein
zero-order light of the first laser light is focused on the signal recording surface of the first optical recording medium; wherein
first-order diffracted light of the second laser light is focused on the signal recording surface of the second optical recording medium; and wherein
first-order diffracted light of the third laser light is focused on the signal recording surface of the third optical recording medium.

12. The objective lens according to claim 11, wherein
the first laser light has a blue-violet wavelength band of 400 nm to 420 nm; wherein
the second laser light has a red wavelength band of 645 nm to 675 nm; wherein
the third laser light has an infrared wavelength band of 765 nm to 805 nm; wherein
NA (Numerical Aperture) is 0.85; wherein
the zero-order light of the first laser light allowed to pass through the objective lens in a range of 0.60<NA, which is the first non-diffraction area, or NA≦0.14, which is the second non-diffraction area, is focused on the signal recording surface of the first optical recording medium; wherein
the first-order diffracted light of the second laser light allowed to pass through the objective lens in a range of 0.14<NA≦0.60, which is the diffraction area, is focused on the signal recording surface of the second optical recording medium; and wherein
the first-order diffracted light of the third laser light allowed to pass through the objective lens in a range of 0.14<NA≦0.47, which is the diffraction area, is focused on the signal recording surface of the third optical recording medium.

13. The objective lens according to claim 11, wherein
the objective lens has a blaze diffraction grating formed, as the diffraction structure, on a lens surface thereof on a side on which the first to third laser light is incident.

14. The objective lens according to claim 13, wherein
the blaze diffraction grating having a blaze height of 1.33 μm is formed on the objective lens in a range of 0.14<NA≦0.60.

15. The objective lens according to claim 11, wherein
a front-side principal point position Δ1 and a rear-side principal point position Δ2 based on a light collection point of the zero-order light of the first optical recording medium satisfy the following relationships:
+0.40≦Δ1/d≦+0.60
−0.50≦Δ2/d≦−0.20
where d denotes a distance between surface tops of the objective lens.

16. The objective lens according to claim 11, wherein
an outside diameter is 5.0 mm.

17. An optical pickup apparatus configured to apply a light flux to an optical recording medium to be rotated and detect the light flux reflected by the optical recording medium, comprising
an objective lens configured to
condense first laser light to a first optical recording medium,
condense second laser light, different in wavelength from the first laser light, to a second optical recording medium, and
condense third laser light, different in wavelength from the first laser light and the second laser light, to a third optical recording medium,
the objective lens including a diffraction area having a diffraction structure provided thereon concentrically around an optical axis of the objective lens and a first non-diffraction area provided outward an outer circumference of the diffraction area,
the objective lens being configured to
focus the first laser light on a signal recording surface of the first optical recording medium by refraction in the first non-diffraction area;
focus the second laser light on a signal recording surface of the second optical recording medium by diffraction in the diffraction area; and
focus the third laser light on a signal recording surface of the third optical recording medium by diffraction in the diffraction area.

18. The optical pickup apparatus according to claim 17, wherein
the diffraction area includes a first diffraction area allowing the third laser light to be focused on the signal recording surface of the third optical recording medium and a second diffraction area provided outward the outer circumference of the first diffraction area, and wherein
the second diffraction area doses not allow the third laser light to be focused on the signal recording surface of the third optical recording medium.

19. The optical pickup apparatus according to claim 17, wherein
a second non-diffraction area is provided inward an inner circumference of the diffraction area and includes the inner circumference.

20. The optical pickup apparatus according to claim 19, wherein
the third laser light allowed to pass through the second non-diffraction area and be condensed is not focused on the signal recording surface of the third optical recording medium.

21. The optical pickup apparatus according to claim 17, wherein
the objective lens is configured to
focus zero-order light of the first laser light on the signal recording surface of the first optical recording medium,
focus second-order diffracted light of the second laser light on the signal recording surface of the second optical recording medium, and
focus second-order diffracted light of the third laser light on the signal recording surface of the third optical recording medium.

22. The optical pickup apparatus according to claim 21, wherein
the first laser light has a blue-violet wavelength band of 400 nm to 420 nm; wherein
the second laser light has a red wavelength band of 645 nm to 675 nm; wherein
the third laser light has an infrared wavelength band of 765 nm to 805 nm; wherein
NA (Numerical Aperture) is 0.85; wherein
the zero-order light of the first laser light allowed to pass through the objective lens in a range of 0.60<NA, which is the first non-diffraction area, or NA≦0.20, which is the second non-diffraction area, is focused on the signal recording surface of the first optical recording medium; wherein
the second-order diffracted light of the second laser light allowed to pass through the objective lens in a range of 0.20<NA≦0.60, which is the diffraction area, is focused on the signal recording surface of the second optical recording medium; and wherein
the second-order diffracted light of the third laser light allowed to pass through the objective lens in a range of 0.20<NA≦0.47 of the objective lens, which is the diffraction area, is focused on the signal recording surface of the third optical recording medium.

23. The optical pickup apparatus according to claim 17, wherein
the objective lens is configured to
focus zero-order light of the first laser light on the signal recording surface of the first optical recording medium,
focus first-order diffracted light of the second laser light on the signal recording surface of the second optical recording medium, and
focus first-order diffracted light of the third laser light on the signal recording surface of the third optical recording medium.

24. The optical pickup apparatus according to claim 23, wherein
the first laser light has a blue-violet wavelength band of 400 nm to 420 nm; wherein
the second laser light has a red wavelength band of 645 nm to 675 nm; wherein
the third laser light has an infrared wavelength band of 765 nm to 805 nm; wherein
NA (Numerical Aperture) is 0.85; wherein
the zero-order light of the first laser light allowed to pass through the objective lens in a range of 0.60<NA, which is the first non-diffraction area, or NA≦0.14, which is the second non-diffraction area, is focused on the signal recording surface of the first optical recording medium; wherein
the first-order diffracted light of the second laser light allowed to pass through the objective lens in a range of 0.14<NA≦0.60, which is the diffraction area, is focused on the signal recording surface of the second optical recording medium; and wherein
the first-order diffracted light of the third laser light allowed to pass through the objective lens in a range of 0.14<NA≦0.47 of the objective lens, which is the diffraction area, is focused on the signal recording surface of the third optical recording medium.
